(19) United States
(12) Patent Application Publication
(10) Pub. No.: US 2011/0248942 A1
(43) Pub. Date: Oct. 13, 2011

(54) IMAGE PICK-UP APPARATUS, DETECTION-FRAME ADJUSTMENT METHOD, AND PROGRAM

(75) Inventors: Kanako YANA, Tokyo (JP); Daijiro Ichijima, Saitama (JP); Yoshihiro Ishida, Tokyo (JP)

(73) Assignee: Sony Corporation, Tokyo (JP)

(21) Appl. No.: 13/069,553

(22) Filed: Mar. 23, 2011

(30) Foreign Application Priority Data
Apr. 13, 2010 (JP) P2010-092645

(51) Int. Cl. G06F 3/041

(52) U.S. Cl. 345/173

(57) ABSTRACT

An image processing apparatus including an interface that acquires image data, a touch panel display that displays the acquired image data and receives a touch input, and a controller that controls a range of a detection frame displayed on the touch panel based on the received touch input.

### CROSS REFERENCE TO RELATED APPLICATION

This application claims the benefit of priority under 35 U.S.C. §119 to Japanese Patent Application No. JP 2010-092645 filed in the Japan Patent Office on Apr. 13, 2010, the entire contents of which is incorporated herein by reference.

### BACKGROUND OF THE INVENTION

1. Field of the Invention

The present invention relates to an image pick-up apparatus, a detection-frame adjustment method, and a program that are used for capturing an image of a subject while displaying the image of the subject on a display unit.

2. Description of the Related Art

Today, many image pick-up apparatuses, such as digital still cameras and digital video cameras, have display units, such as liquid crystal displays, on which images of subjects are displayed. Some image pick-up apparatuses have an automatic focus (AF) function that can be used during image pick-up. Some models of these image pick-up apparatuses have a display unit provided with a touch panel which can be touched to set a position (subject) for AF.

For example, there is a technique that allows a user to adjust the position of an AF area (evaluation frame) for focusing in accordance with a coordinate signal generated by a two-dimensional touch pad when a detection surface of the two-dimensional touch pad is touched by the user (for example, refer to Japanese Unexamined Patent Application Publication No. 10-173980).

### SUMMARY OF THE INVENTION

However, with the technique described in Japanese Unexamined Patent Application Publication No. 10-173980, the position of an AF area is assigned by moving an evaluation frame fixed within a predetermined rage, and the focus position (subject) and range of the evaluation frame is not specified within the evaluation frame. Here, an evaluation frame according to Japanese Unexamined Patent Application Publication No. 10-173980 has been described as an example. In such related art, the position and range of a frame (hereinafter referred to as “detection frame”) provided to carry out predetermined image processing on an image could not be finely adjusted.

Embodiments of the present invention have been conceived in light of such circumstances and enable control of the range of a detection frame with respect to an image displayed on a display unit by simple operation.

According to one exemplary embodiment, the disclosure is directed to an image processing apparatus including an interface that acquires image data, a touch panel display that displays the acquired image data and receives a touch input, and a controller that controls a range of a detection frame displayed on the touch panel display based on the received touch input.

An embodiment of the present invention allows for control of the range of a detection frame with respect to an image displayed on a display unit by simple operation, such as pushing a pointing object into a display unit.

### BRIEF DESCRIPTION OF THE DRAWINGS

FIG. 1 is a block diagram illustrating the internal configuration of an image pick-up apparatus according to a first embodiment of the present invention;

FIG. 2 is a block diagram illustrating the internal configuration of a control unit according to the first embodiment of the present invention;

FIG. 3 illustrates an example operation for changing a focus frame according to the first embodiment of the present invention;

FIG. 4 is a flow chart illustrating the process performed by a coordinate acquiring unit acquiring coordinates in the first embodiment of the present invention;

FIG. 5 is a flow chart illustrating a process of a frame setting unit when the pointing object is released from the touch panel in the first embodiment of the present invention;

FIG. 6 is a flow chart illustrating the process of changing the focus frame performed by a frame setting unit when the pressure of the pointing object applied to the touch panel changes in the first embodiment of the present invention;

FIG. 7 illustrates the outline of the process of changing the focus frame performed by the frame setting unit when an object is detected in the image inside the focus frame in the first embodiment of the present invention;

FIG. 8 illustrates a method of shrinking a focus frame performed by the frame setting unit when an object is depicted in an image inside the focus frame in the first embodiment of the present invention;

FIG. 9 illustrates a method of shrinking a focus frame performed by the frame setting unit when an object is depicted in an image inside the focus frame in the first embodiment of the present invention;

FIG. 10 illustrates a process of changing a focus frame performed by the frame setting unit when an object is depicted in an image inside the focus frame in the first embodiment of the present invention;

FIG. 11 is a first graph illustrating the relationship between pressure and the range of a focus frame when an object is not detected in the focus frame depicted in an image in the first embodiment of the present invention;

FIG. 12 is a second graph illustrating the relationship between pressure and the range of a focus frame when an object is not detected in the focus frame depicted in an image in the first embodiment of the present invention; and

FIG. 13 illustrates an example operation of changing a focus frame in the second embodiment of the present invention in a second embodiment of the present invention.

### DESCRIPTION OF THE PREFERRED EMBODIMENTS

Embodiments of the present invention will be described below with reference to the accompanying drawings. The outline of the descriptions is as follows.

1. First embodiment (frame setting unit: changing the range of a detection frame in response to pressure)

2. Second embodiment (frame setting unit: changing the size of a subject while a detection frame is fixed)

3. Variation (frame setting unit: setting the range of a detection frame by changing the operation mode)

### First Embodiment

### Configuration of Image Pick-Up Apparatus

An embodiment of the present invention will be described below with reference to the accompanying drawings. In this embodiment, an image pick-up apparatus 100 that has a touch panel for input operation will be described.

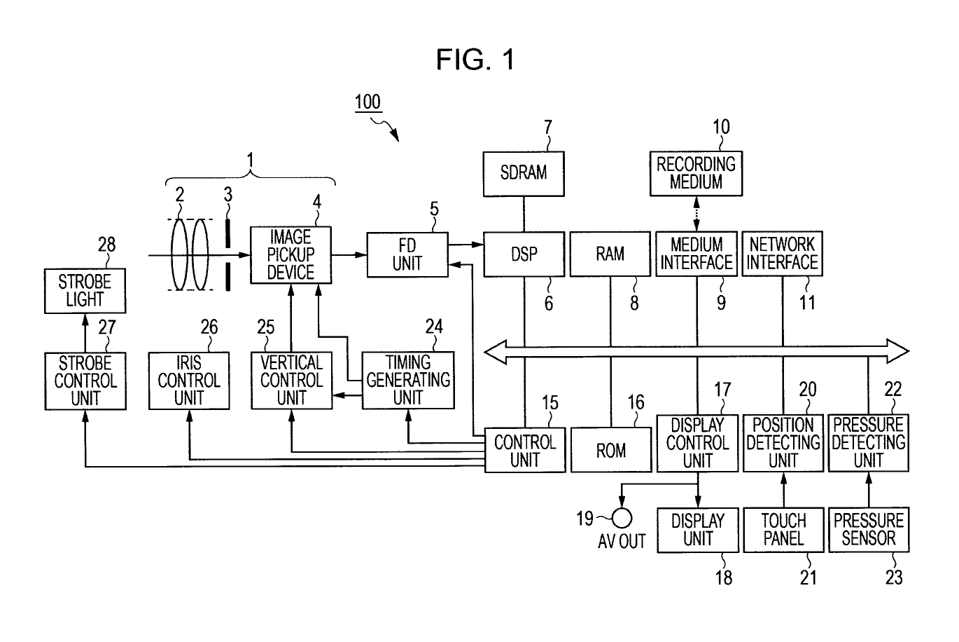

FIG. 1 is a block diagram illustrating the internal configuration of the image pick-up apparatus 100.

The image pick-up apparatus 100 includes an image pick-up unit 1 that has a plurality of lenses, a mechanical shutter, and an aperture stop. The image pick-up unit 1 outputs, as an image signal, light from a subject forming an image on an image pick-up element 4 after being transmitted through an optical system 2. The image pick-up unit 1 includes a shutter/iris 3 that carries out shutter operation for the light image transmitted through the optical system 2 and the image pick-up element 4 that outputs an analog image signal generated from the light image forming an image. The image pick-up element 4 may be a charge coupled device (CCD) imager or a complementary metal oxide semiconductor (CMOS) sensor.

The image pick-up apparatus 100 includes a front-end unit 5 that adjusts the gain and exposure of an analog image signal input from the image pick-up element 4 and converts the analog signal to a digital signal and a digital signal processor (DSP) 6 that performs predetermined signal processing on the digital signal output from the front-end unit 5. The DSP 6 includes a synchronous dynamic random access memory (SDRAM) 7 and writes in and reads out variables and parameters if necessary.

The image pick-up apparatus 100 further includes a RAM 8 used as a work area where various data items are temporarily stored and a medium interface 9 that controls reading and writing of an image acquired from the digital image signal to and from a recording medium 10, such as a flash memory. As the recording medium 10, for example, a memory card having a semiconductor memory is used. The image pick-up apparatus 100 further includes a network interface 11 that controls processing for sending out and taking in images to and from a computer (not shown) connected via a USB cable.

The image pick-up apparatus 100 further includes a control unit 15 that controls the operation of each processing block and a ROM 16 where programs and so on are stored. The image pick-up apparatus 100 further includes a display control unit 17 that displays an image on a display unit 18 on the basis of the digital image signal and an image output unit that outputs the image to an external monitor etc. The image pick-up apparatus 100 further includes a touch panel 21 on which a user performs input operation using an pointing object (the user's finger, a stylus, etc.) and a position detecting unit 20 that detects the coordinates of the contact position of the pointing object on the display unit 18 on which an image based on an image signal is displayed. The touch panel 21 has a size of, for example, 3 to 3.5 inches and a screen aspect ratio of 16:9. The position detecting unit 20 is an example of a contact-position detecting unit. In general, there are two types of contact-position detecting units: a pressure sensitive type unit that detects a change in pressure and an electrostatic type unit that detects an electric signal generated by static electricity.

The image pick-up apparatus 100 further includes a pressure sensor 23 that is disposed over the touch panel 21 and a pressure detecting unit 22 that detects pressure applied to the pressure sensor 23. The pressure detecting unit 22 converts an analog signal output from the pressure sensor 23 to a digital signal and sends the digital signal to the control unit 15.

The image pick-up apparatus 100 further includes a timing generating unit 24 that generates, through control by the control unit 15, a timing signal for synchronizing the operation timing of all units and a vertical control unit 25 that controls the vertical readout of the image pick-up element 4. The vertical control unit 25 reads out an analog signal from the image pick-up element 4 in synchronization with a timing signal from the timing generating unit 24. The image pick-up apparatus 100 further includes an iris control unit 26 that controls the operation timing of the shutter/iris 3 and a strobe control unit 27 that controls the light-emission timing of a strobe light 28 emitting strobe light to the subject.

Next, the operation of the units in the image pick-up apparatus 100 will be described.

When a shutter button (not shown) is pushed by a user, the control unit 15 instructs the shutter/iris 3 to operate the iris and the shutter. When the environment is dark, the control unit 15 controls the strobe control unit 27 to emit light from the strobe light 28. The program operated by the control unit 15 is read out from the ROM 16 and writes in control parameters and so on to the RAM 8.

The intensity of light from the subject transmitted through the optical system 2 is adjusted at the shutter/iris 3, and then an image is formed on the image pick-up element 4.

The image pick-up element 4 outputs an analog image signal based on the formed image, and the front-end unit 5 converts the analog image signal to a digital image signal, removes noise, and amplifies the digital image signal. The timing of reading out an analog image signal from the image pick-up element 4 and the timing of outputting a digital image signal from the front-end unit 5 are controlled by the control unit 15. The DSP 6 performs various types of correction after receiving a digital image signal from the front-end unit 5 and then stores an image based on the digital image signal output via the medium interface 9 on a recording medium.

The DSP 6 outputs a digital image signal to the display control unit 17 and displays a through image of the subject, which is an image not stored in the recording medium 10 by operating shutter. The user can set the operation of the image pick-up apparatus 100 by contacting the touch panel 21 with a pointing object. Such setting includes switching of the menu screens and changing image pick-up modes.

Then, upon receiving the coordinates of the pointing object in contact with the touch panel 21 from the position detecting unit 20, the control unit 15 operates the units in accordance with instructions. For example, the control unit 15 detects an object (subject), such as a face, depicted in the image inside a focus frame, which is a detecting frame, and focuses onto the detected object. Furthermore, the control unit 15 instructs the display control unit 17 to display various items of information on the display unit 18. In this embodiment, the detecting frame is used as a focus frame, but in addition, it may also be used in other types of image processing.

The control unit 15 acquires, from the position detecting unit 20, start-point coordinates of a start point at which the pointing object contacts the touch panel 21 and end-point coordinates of an end point at which the pointing object is released from the touch panel 21 after moving along the touch panel 21. The control unit 15 acquires, from the pressure detecting unit 22, information about the pressure applied to the pressure sensor 23 when the pointing object is in contact with the touch panel 21.

Furthermore, when a USB cable is connected to the network interface 11, the control unit 15 outputs an image read out from the recording medium 10 to the network interface 11 in accordance with an instruction from an external computer.

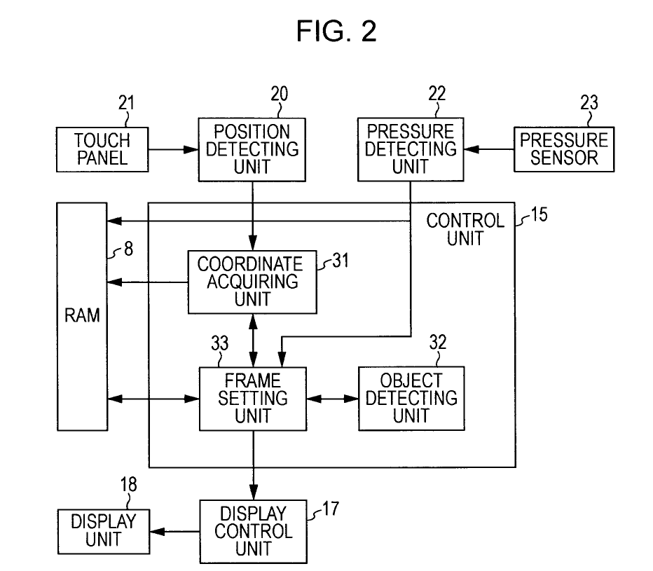

FIG. 2 is a block diagram illustrating the internal configuration of the control unit 15.

The control unit 15 includes a coordinate acquiring unit 31, an object detecting unit 32, and a frame setting unit 33.

The coordinate acquiring unit 31 acquires, from the position detecting unit 20, the coordinates of a pointing object contacting the touch panel 21. Among the coordinates received from the optical system 20, the coordinates of the position the pointing object first contacts the touch panel 21 is written in a first storage area in the RAM 8 as the start point coordinates (start point position). The coordinate acquiring unit 31 continues to acquire the coordinates of the pointing object as the pointing object moves on the touch panel 21 and writes over a second storage area in the RAM 8 until the pointing object is released from the touch panel 21, i.e., until the pointing object reaches the end-point coordinate (end point position). Such operation by the user is referred to as “dragging” and is performed to, for example, move the focus frame.

Simultaneously with the processing by the position detecting unit 20, the pressure detecting unit 22 outputs a digital signal (pressure information) based on the pressure detected at the pressure sensor 23 to the control unit 15. Then, the pressure information input to the control unit 15 is input to the frame setting unit 33, linked with the coordinates of the pointing object, and written in the RAM 8 from the pressure detecting unit 22.

While the pointing object is in contact with the touch panel 21 from the point the coordinate acquiring unit 31 acquires the coordinates of the start point position, the frame setting unit 33 sets the range (area) of the focus frame in accordance with the operation of the pointing object. Upon receiving a notification that the pointing object has contacted the touch panel 21 from the coordinate acquiring unit 31, the frame setting unit 33 continues to detect the contact state until the pointing object is released from the touch panel 21. At this time, the frame setting unit 33 detects, on the basis of the pressure information, an instruction from the pointing object for changing the range of the focus frame when the pressure applied by the pointing object increases while the pointing object moves from the start point coordinates to the end point coordinates. Then, an instruction is sent to the display control unit 17 for displaying a focus frame having a range corresponding to the instruction at a position on the screen of the display unit 18 corresponding to the contact point of the pointing object detected by the position detecting unit 20.

At this time, the frame setting unit 33 sets the range of the focus frame in accordance with the pressure applied from the pointing object to the pressure sensor 23 or the range of the object (subject) detected in the focus frame displayed first. Whether an object (subject) is captured inside the focus frame depicted in the image displayed on the display unit 18 is determined by the object detecting unit 32 in response to an instruction from the frame setting unit 33 using an image processing technique according to the related art on the image inside the focus frame.

The display unit 18 displays the focus frame on the screen by control of the display control unit 17. On the screen of the display unit 18, a focus frame having a range corresponding to the pressure applied from the pointing object to the pressure sensor 23 or the object (subject) detected inside the focus frame displayed at first is displayed.

### Outline of Operation and Display

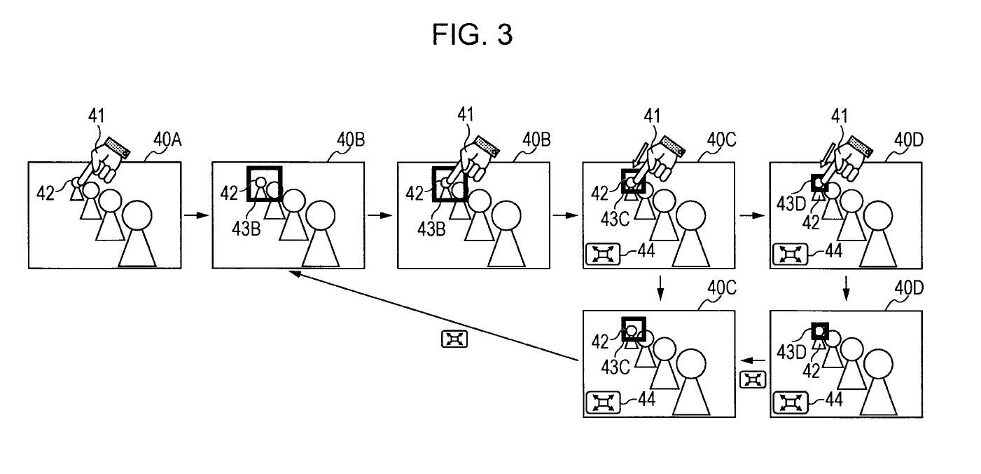

FIG. 3 illustrates an example operation for changing a focus frame in the first embodiment of the present invention.

In this embodiment, the touch panel 21 and the pressure sensor 23 are disposed over the upper surface of the display unit 18. Therefore, the display range (screen) of the display unit 18 on which an image is displayed and the detection range of the pressure sensor 23 for detecting pressure applied by the pointing object are substantially the same. The control unit 15 performs control for displaying the focus frame in accordance with the contact point of the pointing object on the touch panel 21 and the pressure applied by the pointing object. The image pick-up apparatus 100 focuses on the object (subject) surrounded by the focus frame in the image.

In FIG. 3, an image 40A displayed on the display unit 18 depicts four people lined up from back to front. When the user uses his/her finger 41 to touch an area on the touch panel 21 corresponding to person 42, the image 40A transforms to an image 40B. The image 40B depicts a focus frame 43B centered on the contact point of the finger 41 detected by the position detecting unit 20.

At this point, the user pushes an area inside the focus frame 43B in the image 40B with his/her finger 41 to apply pressure. In response, the focus frame 43B shrinks, and a focus frame 43C having a size that just fits around the head of the person 42 inside the focus frame 43B is displayed (image 40C). At this time, an enlarge button 44 for enlarging the shrunk focus frame appears in the image 40C. When the area of the enlarge button 44 in the image 40C is pushed, the focus frame 43C is enlarged into the focus frame 43B larger than the focus frame 43C, causing the image 40C to transform to the image 40B.

The user pushes the touch panel 21 with his/her finger 41 in an area inside the focus frame 43C in the image 40C to apply greater pressure. In response, the focus frame 43C shrinks, and a focus frame 43D having a size that just fits around the head of the person 42 inside the focus frame 43C is displayed (image 40D). When the area of the enlarge button 44 in the image 40D is pushed, the focus frame 43D is enlarged into the focus frame 43C larger than the focus frame 43D, causing the image 40D to transform to the image 40C.

As illustrated in FIG. 3, usability is improved by providing an enlarge button for changing the size of the focus frame on the screen such that the focus frame shrunk by the pushing operation enlarged to its original size.

### Operation of Coordinate Acquiring Unit

Next, the process of the coordinate acquiring unit 31 acquiring coordinates will be described.

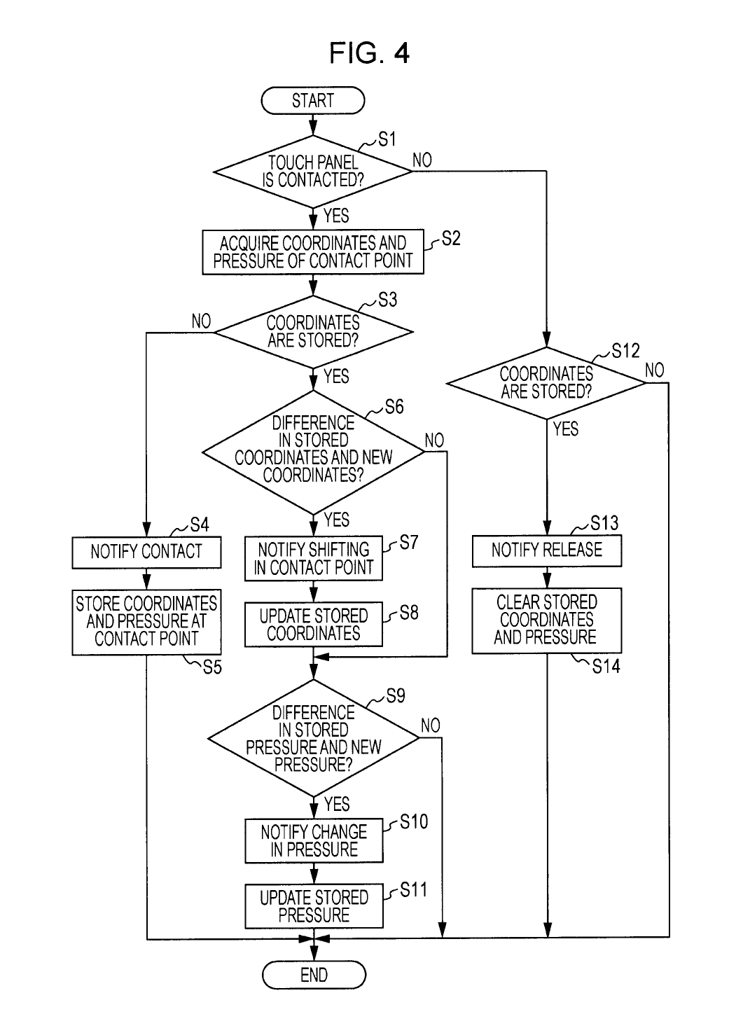

FIG. 4 is a flow chart illustrating the process performed by the coordinate acquiring unit 31 acquiring coordinates. The coordinate acquiring unit 31 constantly carries out Steps S1 to S10, which are described below, in synchronization with timing signals output from the timing generating unit 24.

First, the coordinate acquiring unit 31 determines whether the pointing object (finger 41 in this embodiment) has contacted the touch panel 21 (Step S1). When it is determined that the pointing object is in contact with the touch panel 21, the coordinate acquiring unit 31 acquires the coordinates of the contact point of the pointing object (Step S2).

Then, the coordinate acquiring unit 31 determines whether coordinates are stored in the RAM 8 (Step S3). When coordinates are not stored in the RAM 8, the coordinate acquiring unit 31 notifies the frame setting unit 33 that the pointing object has contacted the touch panel 21 for the first time (Step S4). The coordinate acquiring unit 31 writes the coordinates of the contact point in the RAM 8, holds the coordinates as the start point position (Step S5), and then, ends the process.

In Step S3, when it is determined that coordinates are stored in the RAM 8, the coordinate acquiring unit 31 determines whether there is a difference between the coordinates stored in the RAM 8 and the newly acquired coordinates (Step S6). When there is a difference between the coordinates stored in the RAM 8 and the newly acquired coordinates, the coordinate acquiring unit 31 notifies the frame setting unit 33 that the contact point of the pointing object on the touch panel 21 has moved (Step S7). The coordinate acquiring unit 31 writes the coordinates of the pointing object after being moved, updates the coordinates stored in the RAM 8 (Step S8), and then, ends the process.

In Step S6, when it is determined that there is no difference between the coordinates stored in the RAM 8 and the newly acquired coordinates, the coordinate acquiring unit 31 notifies that the contact point of the pointing object on the touch panel 21 has not moved (Step S9) and then, ends process.

In Step S1, when it is determined that the pointing object in not in contact with the touch panel 21, the coordinate acquiring unit 31 determines whether coordinates are stored in the RAM 8 (Step S10). When coordinates are stored in the RAM 8, the coordinate acquiring unit 31 notifies the frame setting unit 33 that the pointing object has been released from the touch panel 21 (Step S11). The coordinate acquiring unit 31 deletes the coordinates stored in the RAM 8 (Step S12), and then, ends the process.

In Step S10, when it is determined that coordinates are not stored in the RAM 8, the coordinate acquiring unit 31 ends the process.

### Operation of Frame Setting Unit

While the coordinate acquiring unit 31 acquires the coordinates of the contact point of the pointing object, the frame setting unit 33 acquires information about the pressure of the pointing object from the pressure detecting unit 22. When the pointing object contacts the touch panel 21 and coordinates are stored in the RAM 8, the frame setting unit 33 compares the pressure at the stored coordinates and the pressure at the newly acquired coordinates. Then, when the pressures at the newly acquired coordinate exceeds a first threshold, an instruction for shrinking the focus frame is sent to the display control unit 17.

Subsequently, when the pointing object is in contact with the touch panel 21 and coordinates are stored in the RAM 8, the frame setting unit 33 compares the pressure at the stored coordinates and the pressure at the newly acquired coordinates. Then, when the pressures at the newly acquired coordinate exceeds a second threshold, which is larger than the first threshold, an instruction for further shrinking the focus frame is sent to the display control unit 17.

### Processing For When Pointing Object Is Released From Touch Panel

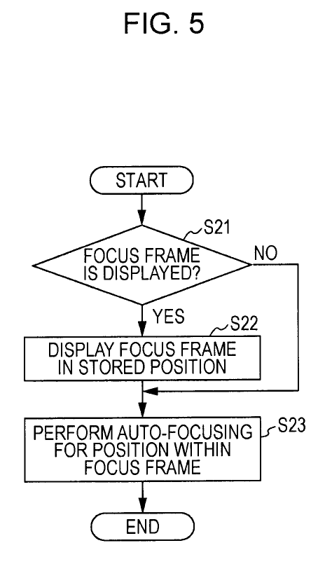

FIG. 5 is a flow chart illustrating a process of the control unit 15 (in particular the frame setting unit 33) when the pointing object is released from the touch panel 21.

This process is carried out when the coordinate acquiring unit 31 notifies the frame setting unit 33 that the pointing object has been released from the touch panel 21 (S11 in FIG. 4).

First, when it is notified that the pointing object has been released from the touch panel 21, the frame setting unit 33 determines whether the focus frame is displayed on the display unit 18 (Step S21). When it is determined that the focus frame is not displayed on the display unit 18, the frame setting unit 33 instructs the display control unit 17 to display the focus frame at a position centered on the point corresponding to the coordinates stored in the RAM 8 (Step S22). Then, automatic focusing is performed on the object depicted in the image inside the displayed focus frame (Step S23), and the process ends.

The focus frame is not displayed on the display unit 18, for example, when image data of the focus frame is being prepared or, as described below, when image processing for enlarging the object inside the focus frame to match the range of the focus frame is carried out.

In Step S21, when the focus frame is displayed on the display unit 18, the process proceeds to Step S23 to carry out automatic focusing on the object depicted in the image inside the displayed focus frame, and then, the process ends.

### Processing For When Pressure Applied By Pointing Object Changes

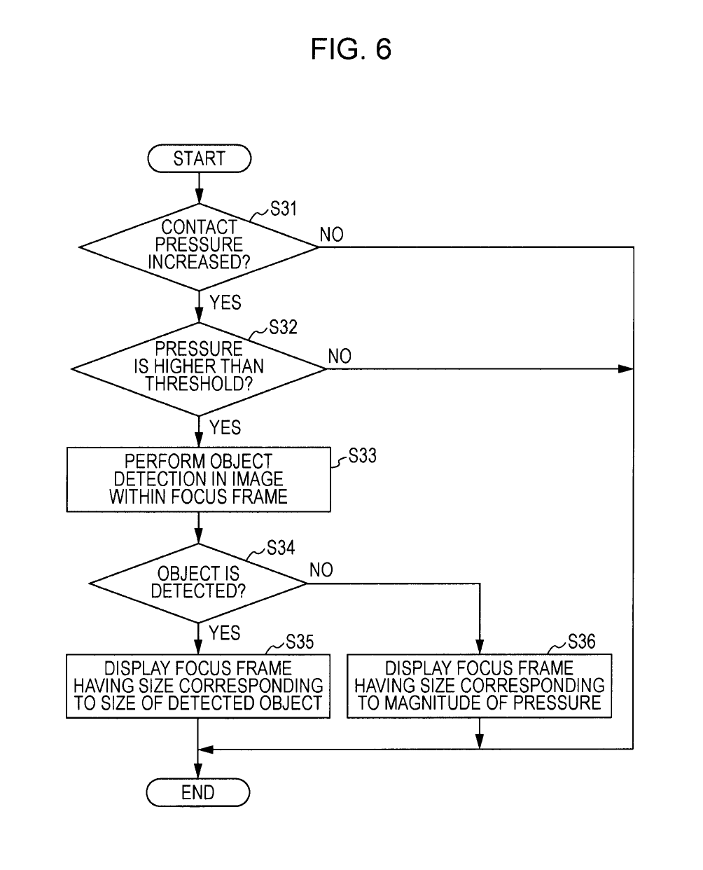

FIG. 6 is a flow chart illustrating the process of changing the focus frame by the control unit 15 (in particular the frame setting unit 33) when the pressure of the pointing object applied to the touch panel 21 changes.

This process is carried out when the coordinate acquiring unit 31 notifies the frame setting unit 33 that the pointing object is in contact with the touch panel 21 and coordinates are stored in the RAM 8 (Steps S7 and S9 in FIG. 4).

When it is notified that the pointing object is in contact with the touch panel 21 and coordinates are stored in the RAM 8, the frame setting unit 33 compares the pressure information from the pressure detecting unit 22 and the pressure information stored in the RAM 8 and determines whether the pressure has increased (Step S31). When the pressure has increased, the frame setting unit 33 determines whether the increased pressure is greater than or equal to a threshold (Step S32).

In Step S32, when the pressure is determined to be greater than or equal to the threshold, the frame setting unit 33 instructs the object detecting unit 32 to detect the object (subject), such as a face, depicted in the image inside the focus frame. The object detecting unit 32 receives the instruction from the frame setting unit 33 and detects the object in the image inside the focus frame (Step S33).

The frame setting unit 33 receives the detection result of the object detecting unit 32 and determines whether an object has been detected in the image inside the focus frame (Step S34). When an object is detected in the image inside the focus frame, the frame setting unit 33 sets the range of the focus frame in accordance with the size of the detected object. Then, the frame setting unit 33 instructs the display control unit 17 to display the focus frame with the set range. The display control unit 17 instructs the display unit 18 to display the focus frame having the set range (Step S35), and then, ends the process. The method of setting the range of the focus frame in accordance with the size of the detected object will be described below.

In Step S34, when an object is not detected in the image inside the focus frame, the frame setting unit 33 sets the range of the focus frame in accordance with the pressure applied to the touch panel 21 by the pointing object. Then, the frame setting unit 33 instructs the display control unit 17 to display, when pressure is applied, the focus frame having the set range at a position centered on the point corresponding to the coordinates stored. The display control unit 17 instructs the display unit 18 to display the adjusted focus frame having the set range (Step S36) and then, ends the process. The method of setting the range of the focus frame in accordance with the pressure applied to the touch panel 21 by the pointing object will be described below.

When it is determined in Step S31 that pressure has not increased, or when it is determined in Step S32 that the increased pressure is not greater than or equal to a threshold, the frame setting unit 33 ends the process.

FIG. 6 illustrates a case of a single cycle, and the process illustrated in FIG. 6 is repeated while the coordinate acquiring unit 31 detects that the pointing object is in contact with the touch panel 21 and coordinates are stored in the RAM 8. Then, When the coordinate acquiring unit 31 determines that the pointing object has been released from the touch panel 21 after the process illustrated in FIG. 6 for when the pressure of the pointing object is changed is carried out, the pointing object illustrated in FIG. 5 carries out the process for when the pointing object is released from the touch panel 21.

### Setting Focus Frame When Object Is Detected

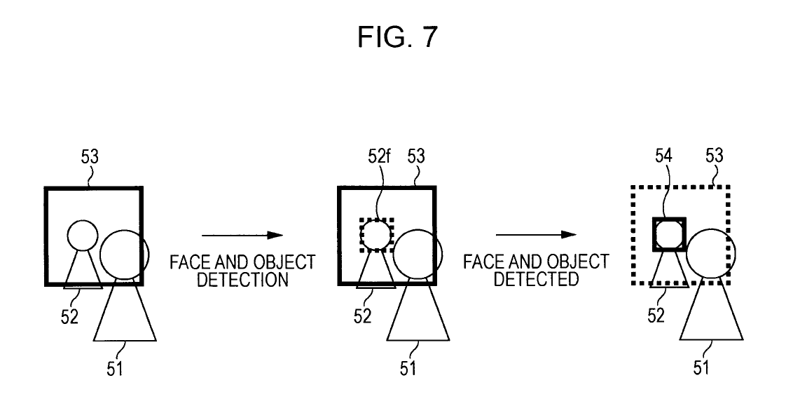

FIG. 7 illustrates the outline of the process of changing the focus frame performed by the frame setting unit 33 when an object, such as a face, is detected in the image inside the focus frame. Through this processing, the focus frame is shrunk to fit the size of the detected object, e.g., face. FIG. 7 corresponds to the process carried out when an object is detected in Step S35 in FIG. 6.

An image of persons 51 and 52 captured by the image pick-up unit 1 is displayed on the display unit 18. At the current moment, a focus frame 53 is displayed in such a manner that it fits around the person 52 and the head of the person 51. At this point, the user pushes a point inside the focus frame 53 on the touch panel 21, and the frame setting unit 33 detected that the touch panel 21 has been pushed by a pressure greater than or equal to a threshold on the basis of the pressure information from the pressure detecting unit 22 (YES in Step S33 in FIG. 6). The frame setting unit 33 instructs the object detecting unit 32 to perform object detection using face information and color information (Step S34 in FIG. 6). Then, the frame setting unit 33 recognizes an object, such as a face, in the image inside the focus frame 53 on the basis of the detection result of the object detecting unit 32 (YES in Step S35 in FIG. 6). FIG. 7 illustrates an example in which the focus frame 53 is shrunk to size that fits around head 52f of the person 52, i.e., a focus frame 54 is displayed around the head 52f of the person 52 (Step S36 in FIG. 6).

### An Example In Which Focus Frame Is Shrunk On Basis of Number of Objects

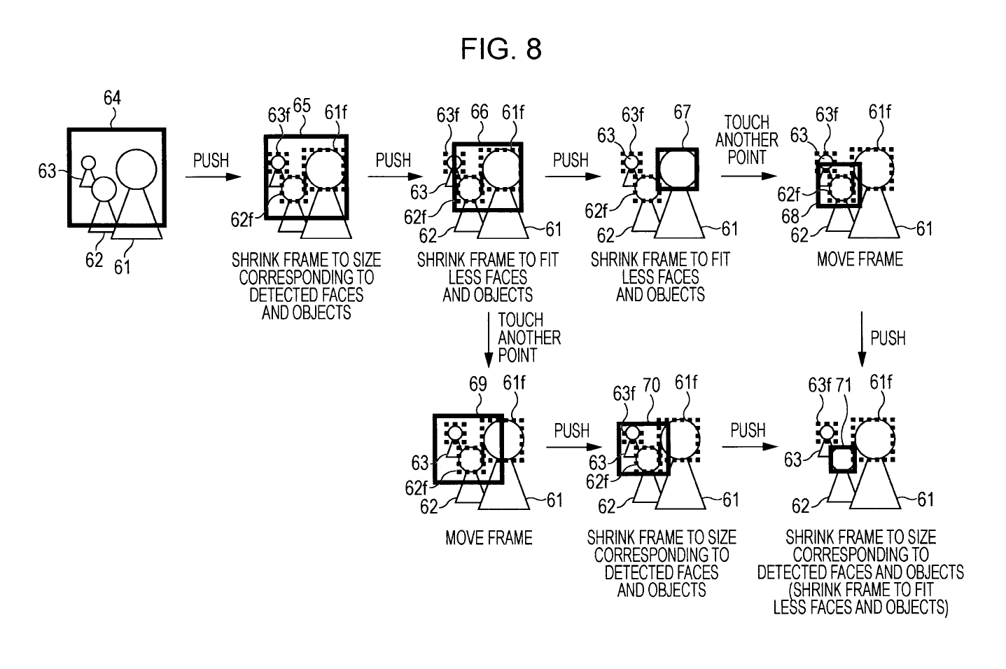

FIG. 8 illustrates a method of shrinking a focus frame by the frame setting unit 33 when an object, such as a face, is depicted in an image inside the focus frame. According to the method, the focus frame is first set to a size that surrounds all detected objects, such as faces, and, then, when the touch panel 21 is pushed further, the number of objects fit into the focus frame is reduced.

An image of persons 61, 62, and 63 captured by the image pick-up unit 1 is displayed on the display unit 18. At the current moment, a focus frame 64 is displayed in such a manner that it fits around the persons 61, 62, and 63. At this point, the user pushes any point inside the focus frame 64 on the touch panel 21, and the frame setting unit 33 detected that the touch panel 21 has been pushed by a pressure greater than or equal to a threshold on the basis of the pressure information from the pressure detecting unit 22.

The frame setting unit 33 detects that the selected point on the touch panel 21 inside the focus frame 64 has been pushed with pressure greater than or equal to the first threshold. In such a case, the frame setting unit 33 sets the range of the focus frame such that the focus frame 64 is slightly shrunk to fit around the detected objects (in this embodiment, the focus frame 64 fits around the heads 61f, 62f, and 63f of the persons 61, 62, and 63). Then, the display control unit 17 is instructed to display a focus frame 65, which is the newly set focus frame. The focus frame 65, which is smaller than the focus frame 64, is displayed on the display unit 18.

Subsequently, when the pointing object in contact with the touch panel 21 is pushed with pressure greater than or equal to a second threshold, which is greater than first threshold, the frame setting unit 33 detects that the pointing object is pushed with pressure greater than or equal to a second threshold, which is greater than first threshold. In such a case, the frame setting unit 33 shrinks the range of the focus frame such that the number of heads fit in the focus frame is reduced to the two heads 61f and 62f. Then, the display control unit 17 is instructed to display a focus frame 66, which is the newly set focus frame. The focus frame 66, which is smaller than the focus frame 65, is displayed on the display unit 18.

Furthermore, when the pointing object in contact with the touch panel 21 is pushed with pressure greater than or equal to a third threshold, which is greater than the second threshold, the frame setting unit 33 detects that the pointing object is pushed with pressure greater than or equal to a third threshold, which is greater than the second threshold. In such a case, the frame setting unit 33 shrinks the range of the focus frame such that the number of heads fit in the focus frame is reduced to the heads 61f. Then, the display control unit 17 is instructed to display a focus frame 67, which is the newly set focus frame. The focus frame 67, which is smaller than the focus frame 66, is displayed on the display unit 18.

Here, the user touches (or drags) another area on the touch panel 21, e.g., an area including the head 62f of the person 62. In this case, the frame setting unit 33 instructs the display control unit 17 to move the focus frame 67 such that a focus frame 68 having the same size as the focus frame 67 is displayed to surround the head 62f. The focus frame 68, having the same size as the focus frame 67, is displayed to surround the 62f on the display unit 18.

When the focus frame 66 is displayed on the display unit 18, the user touches (or drags) another area on the touch panel 21, e.g., an area including the heads 62f and 53f of the persons 62 and 63. In this case, the frame setting unit 33 instructs the display control unit 17 to move the focus frame 66 such that a focus frame 68 having the same size as the focus frame 67 is displayed to surround the head 62f and 63f. The focus frame 68, having the same size as the focus frame 66, is displayed to surround the head 62f and 63f on the display unit 18.

When a point inside the focus frame 69 on the touch panel 21 is pushed, the frame setting unit 33 detects that the point inside the focus frame 69 is pushed with pressure greater than or equal to a first threshold. In this case, the frame setting unit 33 sets the range of the focus frame to a slightly shrunk focus frame 70 surrounding the heads 62f and 63f. Then, the display control unit 17 is instructed to display the focus frame 70 shrunk after setting. The focus frame 70, which is smaller than the focus frame 69, is displayed on the display unit 18.

Furthermore, when the pointing object in contact with the touch panel 21 is pushed with pressure greater than or equal to a second threshold, which is greater than the first threshold, the frame setting unit 33 detects that the touch panel 21 is pushed with pressure greater than or equal to a second threshold, which is greater than the first threshold. In this case, the frame setting unit 33 sets the range of the focus frame to a slightly shrunk focus frame 71 surrounding a smaller number of heads, i.e., only the heads 62f. Then, the display control unit 17 is instructed to display the focus frame 71 shrunk after setting. The focus frame 71, which is smaller than the focus frame 70, is displayed on the display unit 18.

When a point inside the focus frame 68 on the touch panel 21 is pushed, the frame setting unit 33 detects that the point inside the focus frame 68 is pushed with pressure greater than or equal to a first threshold. In this case, the frame setting unit 33 sets the range of the focus frame to a slightly shrunk focus frame 71 surrounding the head 62f. Then, the display control unit 17 is instructed to display the focus frame 71 shrunk after setting. The focus frame 71, which is smaller than the focus frame 68, is displayed on the display unit 18.

In the example illustrated in FIG. 8, when the focus frame is shrunk to a size that surrounds the objects, such as faces, (size that surrounds a reduced number of objects, such as face) detected at the object detecting unit 32, the range of the focus frame is set based on the larger object. For example, shrinking the focus frame 66 to the focus frame 67 and the focus frame 70 to the focus frame 71. However, the size of the focus frame is not limited, and the range of the focus frame may be set to fit the smaller object. In this way, a smaller object can be focused.

In the example illustrated in FIG. 8, when the pressure applied from the pointing object reaches a predetermined value (for example, the second threshold), the range of the focus frame is not changed until the pressure value returns to the previous pressure value (for example, the first threshold). By setting such a rule, the operability can be improved when the pushing operation is performed continuously to set the range of the focus frame since the focus frame does not easily return to the original size.

In the example illustrated in FIG. 8, a detection unit of an object is a head. Instead, however, the detection unit of an object may be a part of a face including, for example, an eye, the mouth, or the nose, or an area including a foot or a finger, and the range of the focus frame may be shrunk to fit these parts. The object being focused includes artificial materials, natural materials, and animals other than humans.

### Example of Shrinking Focus Frame Based On Size of Object

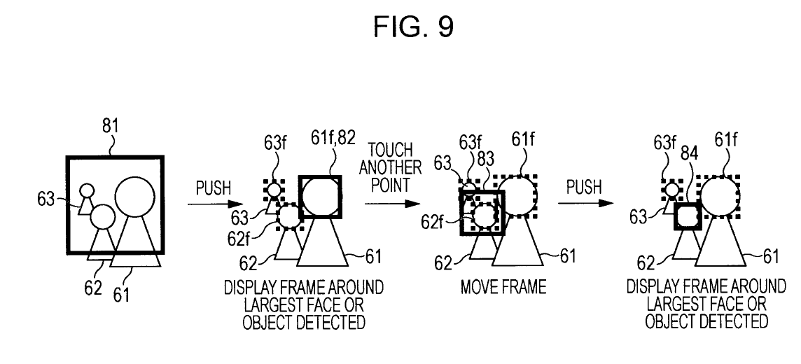

FIG. 9 illustrates a method of shrinking a focus frame by the frame setting unit 33 when an object, such as a face, is depicted inside a focus frame. In the method, the largest detected object, such as a face, is surrounded by a focus frame.

Similar to the example illustrated in FIG. 8, persons 61, 62, and 63 are displayed on the display unit 18. At the current moment, a displayed focus frame 81 (which is substantially the same as the focus frame 64) surrounds the persons 61, 62, and 63 substantially entirely. At this point, the user pushes any point inside the focus frame 81 on the touch panel 21, and the frame setting unit 33 detected that the touch panel 21 has been pushed by a pressure greater than or equal to a threshold on the basis of the pressure information from the pressure detecting unit 22.

The frame setting unit 33 detects that the selected point on the touch panel 21 inside the focus frame 81 has been pushed with pressure greater than or equal to a first threshold. In such a case, the frame setting unit 33 sets the range of the focus frame to fit the largest detected object inside the focus frame 81. In this embodiment, the focus frame is fit to the head 61f among heads 61f, 62f, and 63f of the persons 61, 62, and 63, respectively. Then, the display control unit 17 is instructed to display a focus frame 82 shrunk after setting. The focus frame 82, which is smaller than the focus frame 82, is displayed on the display unit 18.

Here, the user touches (or drags) another area on the touch panel 21, e.g., an area including the head 62f of the person 62. In this case, the frame setting unit 33 instructs the display control unit 17 to move the focus frame 82 such that a focus frame 68 having the same size as the focus frame 83 is displayed to surround the head 62f. The focus frame 83, having the same size as the focus frame 82, is displayed to surround the head 62f on the display unit 18.

Next, when a point inside the focus frame 83 on the touch panel 21 is pushed, the frame setting unit 33 detects that the point inside the focus frame 83 is pushed with pressure greater than or equal to a first threshold. In this case, the frame setting unit 33 sets the range of the focus frame to a slightly shrunk focus frame 83 surrounding the head 62f. Then, the display control unit 17 is instructed to display the focus frame 84 shrunk after setting. The focus frame 84, which is smaller than the focus frame 83, is displayed on the display unit 18.

### Setting Focus Frame When Object Is Not Detected

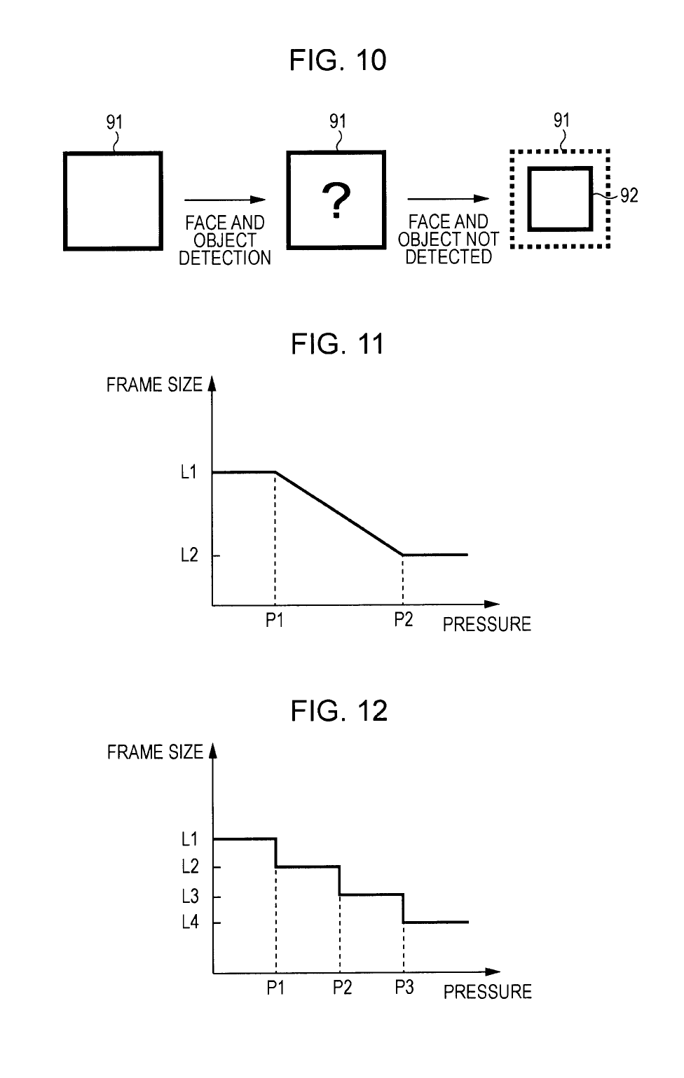

FIG. 10 illustrates the outline of changing process of a focus frame by the frame setting unit 33 when an object, such as a face, is not detected in the image inside the focus frame. In this changing process, the focus frame is shrunk in accordance with pressure when an object, such as a face is not detected.

When a focus frame 91 is depicted in an image displayed on the display unit 18, the frame setting unit 33 changes the focus frame 91 to a shrunk 92 in accordance with the pressure applied when the pointing object is pushed into the touch panel 21.

FIG. 11 is a first graph illustrating the relationship between pressure and the size (range) of a focus frame when an object, such as a face, is not detected in the focus frame depicted in an image.

In this example, the size of the focus frame is shrunk at a constant rate with respect to pressure. For example, when the size of the focus frame is L1 and pressure is P1, and when pressure is P2 (P2<P1), the size of the focus frame is L2 (L1>L2). Between pressure P1 and pressure P2, the size of the focus frame is reduced at a constant rate (slope).

When the size of the focus frame is reduced at a constant rate with respect to pressure, the size of the focus frame may be reduced at a constant rate in response to constantly pushing the touch panel with the pointing object. Instead, the size of the focus frame may be reduced to a predetermined size at once.

FIG. 11 is a second graph illustrating the relationship between pressure and the size (range) of a focus frame when an object, such as a face, is not detected in the focus frame depicted in an image.

In this example, the size of the focus frame is reduced in steps with respect to pressure. For example, when pressure is smaller than P1, the size of the focus frame is L1; when the pressure is between P1 and P2, the size of the focus frame is L2; when the pressure is between P2 and P3, the size of the focus frame is L3; and when pressure is greater than or equal to P3, the size of the focus frame is L4. Thus, the size of the focus frame can be adjusted in four steps.

When the size of the focus frame is reduced in steps with respect to pressure, the size of the focus frame may be reduced in according with the amount of time the pointing object continues to push the touch panel.

### Effect of First Embodiment

According to the first embodiment of the present invention, the range of a focus frame can be automatically adjusted (shrunk) by merely pushing a subject to be focused depicted on a screen. Since the range of the focus frame can be adjusted in accordance with the size of the subject depicted in the image, even when the size of the subject depicted in the image is small, the subject can be easily and quickly focused.

### Second Embodiment

In the second embodiment, unlike the first embodiment (for example, see FIG. 3) in which the range of a focus frame is changed, the image is temporarily enlarged such that it is easy to confirm a subject in a shrunk focus frame depicted in an image.

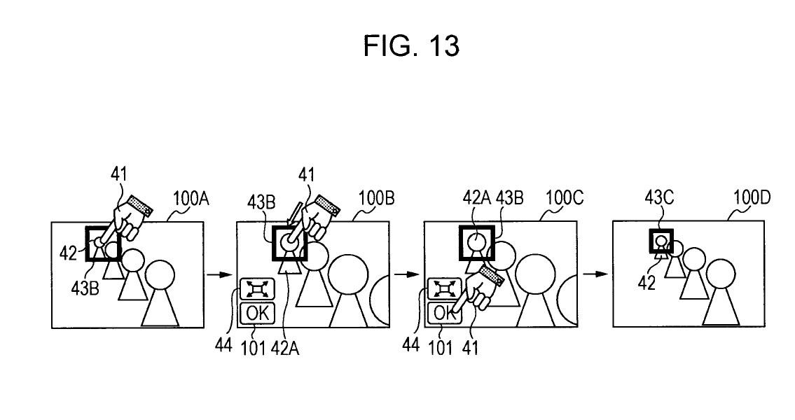

FIG. 13 illustrates an example operation of changing a focus frame in the second embodiment of the present invention.

An image 100A is the same as the image 40B illustrated in FIG. 3. A user pushes the inside of a focus frame 43B depicted in the image 100A with his/her finger 41 to apply pressure. In response, the frame setting unit 33 detects the pressure applied to the inside of the focus frame 43B on the basis of pressure information from the pressure detecting unit 22. Then, the frame setting unit 33 instructs the display control unit 17 to enlarge the image 100A centered on the person 42 while the range of the focus frame 43B is fixed. The display control unit 17 fixes the range of the focus frame 43B and displays an image 100B, which is an enlarged image of the image 100A, on the display unit 18. At this time, the person 42 in the image 100B is enlarged to person 42A, the size of the focus frame 43B is reduced relative to the person 42A, and thus, this is equivalent to shrinking the image. In this case, the real detection area with respect to the subject (person 42) changes. In the image 100B, a setting button 101 (“OK” in FIG. 13) for setting the range of the focus frame is displayed.

In the image 100B, when the part corresponding to the setting button 101 on the touch panel 21 is pushed by a finger 41, the frame setting unit 33 detects that the setting button 101 has been pushed on the bases of information acquired from the coordinate acquiring unit 31. Then, while maintaining the relationship between the image 100B containing the person 42A and so on and the range of the focus frame 43B, the frame setting unit 33 instructs the display control unit 17 to change the image 100B to an image 100C having a magnification the same as the image 100B before enlargement. At this time, a focus frame 43C, which is acquired by shrinking the focus frame 43B with respect to the person 42 in the image 100C, is displayed on the display unit 18.

According to the second embodiment of the present invention, visibility is achieved by displaying an enlarged image, instead of reducing the size of the focus frame. Furthermore, by temporarily enlarging an image when setting the range of a focus frame and shrinking the image to an image having the original magnification, different images can be used for image capturing and focusing, and the usability is improved. The second embodiment also has the same advantages and effects as those according to the first embodiment.

### Variation

In the above-described first and second embodiment, the range of the focus frame is changed by pushing operation of or button operation. Instead, however, the range may be changed using two fingers. For example, after touching the touch panel with two fingers, by moving the fingers in contact with the touch panel closer together, the range of the focus frame is reduced, whereas, by moving the fingers in contact with the touch panel apart from each other, the range of the focus frame is increased. Furthermore, the same effect may be achieved by other operations.

In the first and second embodiment, when the pointing object touches the touch panel and then the position of the pointing object is changed, processing is not particularly changed. However, for example, processing may be cancelled when the pointing object is displaced by a great degree from the original position.

In the first and second embodiment, the change in pressure is continuously monitored (for example, Step S31 in FIG. 6), but this is not limited thereto. For example, the range of the focus frame may be changed each time the pointing object is released from the touch panel.

In the example illustrated in FIG. 5, automatic focusing is performed when the pointing object is released from the touch panel. Instead, however, automatic focusing may be performed while the pointing object is still in contact with the touch panel (for example, in Steps S35 and S36).

The embodiments of the present invention have been described above. The present invention, however, is not limited to the embodiments described above, and various modifications and application are possible within the scope of the invention.

In the embodiments, the steps performed time-sequentially may be performed in the time-sequential order or, instead, may be performed simultaneously or individually (for example, parallel processing or processing using objects).

It should be understood by those skilled in the art that various modifications, combinations, sub-combinations and alterations may occur depending on design requirements and other factors insofar as they are within the scope of the appended claims or the equivalents thereof.

What is claimed is:

1. An image processing apparatus comprising:
an interface configured to acquire image data;
a touch panel display configured to display the acquired image data and receive a touch input; and
a controller configured to control a range of a detection frame displayed on the touch panel display based on the received touch input.

2. The image processing apparatus of claim 1, wherein the displayed image data is an image to be captured by the image processing apparatus.

3. The image processing apparatus of claim 1, wherein the detection frame is a focus frame identifying a portion of the displayed image data on which to perform a focusing operation.

4. The image processing apparatus of claim 1, further comprising:
a position detecting unit configured to detect a location of a touch input received at the touch panel display.

5. The image processing apparatus of claim 4, wherein the controller is configured to control a location of the detection frame based on an output of the position detecting unit.

6. The image processing apparatus of claim 1, further comprising:
a pressure detecting unit configured to detect a pressure of a touch input received at the touch panel display.

7. The image processing apparatus of claim 6, wherein the controller is configured to control a size of the detection frame based on an output of the pressure detecting unit.

8. The image processing apparatus of claim 6, wherein the controller is configured to detect an increase in pressure of a touch input based on the output of the pressure detecting unit, and decrease a size of the detection frame based on the detected increase in pressure.

9. The image processing apparatus of claim 6, wherein the controller is configured to compare an output of the pressure detecting unit to a plurality of predetermined threshold values, which each correspond to a step-wise reduction in a size of the detection frame, and reduce a size of the detection frame based on the comparison.

10. The image processing apparatus of claim 6, wherein the controller is configured to compare an output of the pressure detecting unit to a predetermined threshold value.

11. The image processing apparatus of claim 10, wherein, when the controller determines that the output of the pressure detecting unit exceeds the predetermined threshold value, the controller is configured to reduce a size of the detection frame.

12. The image processing apparatus of claim 11, wherein, when the controller determines that the output of the pressure detecting unit exceeds the predetermined threshold value, the controller is configured to reduce a size of the detection frame based on a length of time the touch input is continuously received.

13. The image processing apparatus of claim 10, wherein, when the controller determines that the output of the pressure detecting unit exceeds the predetermined threshold value, the controller is configured to attempt to detect at least one object within the detection frame.

14. The image processing apparatus of claim 13, wherein, when the controller detects an object within the detection frame, the controller is configured to control a size of the detection frame in accordance with a size of the detected object.

15. The image processing apparatus of claim 13, wherein, when the controller detects an object within the detection frame, the controller is configured to enlarge the detected object without changing a size of the detection frame.

16. The image processing apparatus of claim 13, wherein, when the controller detects a plurality of objects within the detection frame, the controller is configured to control a size of the detection frame based on a number of the detected objects.

17. The image processing apparatus of claim 13, wherein, when the controller detects a plurality of objects within the detection frame, the controller is configured to control a size of the detection frame in accordance with a size of a largest one of the plurality of detected objects.

18. The image processing apparatus of claim 13, wherein, when the controller is not able to detect an object within the detection frame, the controller is configured to control a size of the detection frame based on the output of the pressure detecting unit.

19. The image processing apparatus of claim 10, wherein, when the controller determines that the output of the pressure detecting unit does not exceed the predetermined threshold value, the controller is configured to control a size of the detection frame based on the output of the pressure detecting unit.

20. An image processing method comprising:
acquiring image data;
displaying the acquired image data at a touch panel display;
receiving a touch input at the touch panel display; and
controlling a range of a detection frame displayed on the touch panel display based on the received touch input.

21. The image processing method of claim 20, wherein the displayed image data is an image to be captured.

22. The image processing method of claim 20, wherein the detection frame is a focus frame identifying a portion of the displayed image data on which to perform a focusing operation.

23. The image processing method of claim 20, further comprising:
detecting a pressure of a touch input received at the touch panel display; and
controlling a size of the detection frame based on the detected pressure of the touch input.

24. The image processing method of claim 20, further comprising:
detecting an increase in pressure of a touch input received at the touch panel display; and
decreasing a size of the detection frame based on the detected increase in pressure of the touch input.

25. The image processing method of claim 20, further comprising:
detecting a pressure of a touch input received at the touch panel display;
comparing the detected pressure to a predetermined threshold; and
reducing a size of the detection frame when the detected pressure exceeds the predetermined threshold value.

26. The image processing method of claim 20, further comprising:
detecting a pressure of a touch input received at the touch panel display;
comparing the detected pressure to a predetermined threshold; and
reducing a size of the detection frame when the detected pressure exceeds the predetermined threshold value based on a length of time the touch input is continuously received.

27. The image processing method of claim 20, further comprising:
detecting a pressure of a touch input received at the touch panel display;
comparing the detected pressure to a plurality of predetermined threshold values, which each correspond to a step-wise reduction in a size of the detection frame; and
reducing a size of the detection frame based on the comparison.

28. The image processing method of claim 20, further comprising:
detecting a pressure of a touch input received at the touch panel display;
comparing the detected pressure to a predetermined threshold;
attempting to detect an object within the detection frame when the detected pressure exceeds the predetermined threshold; and
controlling a size of the detection frame in accordance with a size of the detected object when an object is detected.

29. The image processing method of claim 20, further comprising:
detecting a pressure of a touch input received at the touch panel display;
comparing the detected pressure to a predetermined threshold;
attempting to detect an object within the detection frame when the detected pressure exceeds the predetermined threshold; and
enlarging a detected object without changing a size of the detection frame when an object is detected within the detection frame.

30. The image processing method of claim 20, further comprising:
detecting a pressure of a touch input received at the touch panel display;
comparing the detected pressure to a predetermined threshold;
attempting to detect an object within the detection frame when the detected pressure exceeds the predetermined threshold; and
controlling a size of the detection frame based on the detected pressure when an objected is not detected within the detection frame.

31. The image processing method of claim 20, further comprising:
detecting a pressure of a touch input received at the touch panel display;
comparing the detected pressure to a predetermined threshold; and
controlling a size of the detection frame based on the detected pressure when the detected pressure does not exceed the predetermined threshold.

32. A non-transitory computer-readable medium including computer program instructions, which when executed by an image processing apparatus, cause the image processing apparatus to perform a method comprising:
acquiring image data;
displaying the acquired image data on a touch panel display;
receiving a touch input at the touch panel display; and
controlling a range of a detection frame displayed on the touch panel display based on the received touch input.
